(19) United States
(12) Patent Application Publication
(10) Pub. No.: US 2014/0244132 A1
(43) Pub. Date: Aug. 28, 2014

(54) SYSTEM AND METHOD FOR 0N-WING ENGINE TRIM VERIFICATION

(71) Applicant: PRATT & WHITNEY CANADA CORP., Longueuil (CA)

(72) Inventors: David Benjamin MEISELS, Montreal (CA); Gilles LEBOEUF, Beloeuil (CA)

(73) Assignee: PRATT & WHITNEY CANADA CORP., Longueuil (CA)

(21) Appl. No.: 13/774,185

(22) Filed: Feb. 22, 2013

(51) Int. Cl. B64D 31/06

(52) U.S. Cl. CPC B64D 31/06
USPC 701/100

(57) ABSTRACT

Devices and methods relating to gas turbine engines and engine temperature trim verification are disclosed. An exemplary method comprises acquiring signals representing a plurality of engine parameters measured while the engine is operating and determining a recommended trim thermocouple resistance based at least partly on the measured parameters. The engine parameters may comprise at least an engine inlet temperature and an exhaust temperature.

### TECHNICAL FIELD

The disclosure relates generally to gas turbine engines, and more particularly to engine temperature trim verification.

### BACKGROUND OF THE ART

In aircraft employing gas turbine engines, internal engine temperatures are typically “trimmed” or adjusted in relation to the outside air temperature in order to obtain consistent cockpit temperature indications from one engine to another. The process of trimming engines is intended to remove or reduce variation between engines in a consistent manner.

Current commercial engine trim calibration devices are typically bulky and are typically required to be sent to each aircraft/engine to be trim checked. For this and other reasons, improvement in the verification of engine temperature trim is desirable.

### SUMMARY

The disclosure describes systems, devices, and methods relating to gas turbine engines and engine temperature trim verification.

In one aspect, the disclosure describes a method of controlling a temperature trim of a gas turbine engine. The method comprises:
acquiring from transducers associated with the gas turbine engine signals representing a plurality of engine parameters measured while the engine is operating, the parameters comprising at least an engine inlet temperature and an exhaust temperature; and
transmitting signals representing the measured parameters to a processor, the processor determining a recommended trim thermocouple resistance based at least partly on the measured parameters.

In another aspect, the disclosure describes a device useful in controlling a temperature trim of a gas turbine engine. The device comprises:
a processor to control operation of the device; and
a transmission system configured to:
receive from transducers associated with the gas turbine engine, a plurality of engine parameters measured while the engine is operating, the parameters comprising at least an engine inlet temperature and an exhaust temperature; and
transmit signals representing the measured parameters to a processor, the processor determining a recommended trim thermocouple resistance based at least partly on the measured parameters.

In a further aspect, the disclosure describes an aircraft comprising the device.

Further details of these and other aspects of the subject matter of this application will be apparent from the detailed description and drawings included below.

### DESCRIPTION OF THE DRAWINGS

Reference is now made to the accompanying drawings, in which:

FIG. 1 shows an axial cross-section view of an exemplary turbo-fan gas turbine engine;

FIG. 2 shows a schematic diagram of an exemplary engine trim verification system in accordance with the disclosure; and

FIG. 3 shows a flow chart illustrating an exemplary method for verifying engine temperature trim in accordance with the disclosure.

### DETAILED DESCRIPTION OF THE PREFERRED EMBODIMENTS

Various aspects of preferred embodiments are described through reference to the drawings.

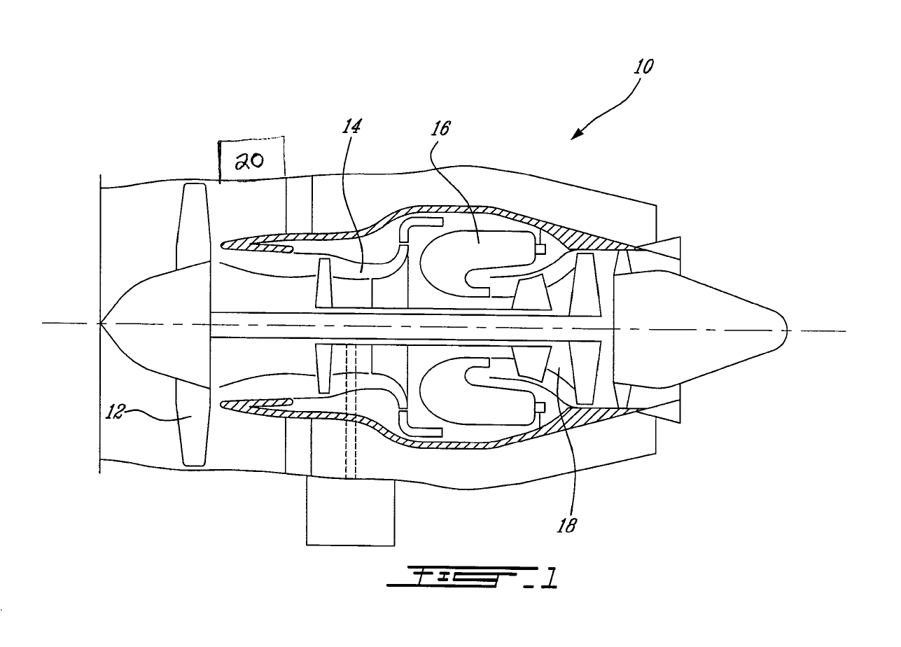

FIG. 1 illustrates an example gas turbine engine 10 of a type preferably provided for use in subsonic flight, generally comprising in serial flow communication a fan 12 through which ambient air is propelled, a multistage compressor 14 for pressurizing the air, a combustor 16 in which the compressed air is mixed with fuel and ignited for generating an annular stream of hot combustion gases, and a turbine section 18 for extracting energy from the combustion gases.

Gas turbine engine 10 may comprise a turbofan engine for use in an aircraft application. Engine 10 may comprise one or more control device(s) 20 which may automatically regulate at least some aspect(s) of operation of engine 10 based on one or more input variable(s). Control device(s) 20 may, for example, be configured to receive multiple input variables representative of current flight conditions including air density, total temperature of inlet air, throttle lever position, engine temperatures, engine pressures, and potentially many other parameters.

Accordingly, control device(s) 20 may receive one or more signal(s) from one or more sensor(s) associated with various aspects of the operation of one or more engine(s) 10. Such signals may be received as input(s) by control device(s) 20 and analyzed by one or more automatic data processor(s) according to stored machine-readable instructions. Engine parameters such as fuel flow, stator vane position, bleed valve position, and others may be computed from this data and applied as appropriate by, for example, generating suitably-configure output signals and providing them to relevant device(s) associated with the engine 10.

In various embodiments, control device(s) 20 may include or form part of a Full Authority Digital Engine Control (FADEC) which may, for example, comprise one or more digital computer(s) or other data processors, sometimes referred to as electronic engine controller(s) (EEC) and related accessories that control at least some aspects of performance of engine 10. Control device(s) 20 may for example be configured to make decisions regarding the control of engine 10 until a pilot wishes to or is required to intervene. Control device(s) 20 may be configured to provide optimum engine efficiency for a given flight condition. As data processors, control device(s) 20 may include one or more microcontroller or other suitably programmed or programmable logic circuits.

Control device(s) 20 may comprise memory(ies) and memory data devices or register(s). Memory(ies) may comprise any storage means (e.g. devices) suitable for retrievably storing machine-readable instructions executable by one or more digital processors. Memory(ies) may be non-volatile. For example, memory(ies) may include erasable programmable read only memory (EPROM) and/or flash memory. Memory(ies) may contain machine-readable instructions for execution by processor(s).

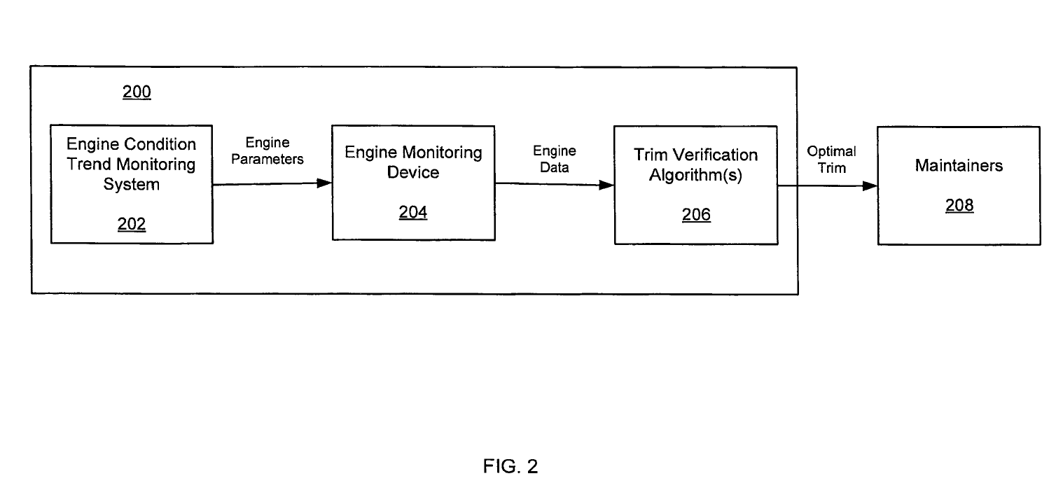

FIG. 2 schematically illustrates an exemplary engine trim verification system 200 which may be used to verify engine temperature trim while an engine 10 is operationally attached to the wing of an aircraft (i.e., the engine is “on-wing”). In the embodiment shown, engine trim verification system 200 comprises an engine condition trend monitoring (ECTM) system 202, an engine monitoring device 204, and one or more processors implementing one or more trim verification algorithms 206. Information from the trim verification system 200 may be provided to one or more maintainers 208 (e.g., members of a ground crew). Engine trim verification system 200 may, for example, be configured for use in conjunction with gas turbine engine 10 of FIG. 1.

The trim verification system 200 and/or the trim verification algorithm(s) 206 may be ground-based or web-based (e.g., as in cloud-computing or group- or wiki-computing), or otherwise separate from the operational algorithm(s) onboard the aircraft or engine 10. Such separation may help to ensure that the trim calculations may be controlled and/or modified separately from the operation of the engine 10 already in service. In some examples, calculation(s) carried out in the trim verification algorithm(s) 206 may also include information (e.g., proprietary engine information) that may not be accessible to the aircraft or engine operator. In some examples, the trim verification algorithm(s) 206 and/or portions of the trim verification system 200 may be accessible only by authorized users (e.g., highly knowledgeable power users).

Condition monitoring of a gas turbine engine 10 may include an assessment of factors indicative of the operational health of the engine 10 in order, for example, to provide early warning of potential failure such that preventative maintenance action may be taken. To achieve this, one or more health monitoring systems, such as ECTM system 202, may be embedded within an engine unit such as gas turbine engine 10. In some embodiments, ECTM system 202 may be used in conjunction with maintenance hardware, such as various harnesses, fittings and sensors, such as the sensors configured provide input to control device(s) 20, useful in detecting or measuring one or more engine conditions or parameters such as, for example, torque, speed, engine internal temperature (ITT or T4), air temperature, altitude and fuel flow. This maintenance hardware may be flight-worthy hardware embedded within the engine or it may be external hardware which may be connected to the engine by appropriate personnel, such as during testing or other maintenance operations.

In some embodiments, engine trim verification system 200 may be configured to measure one or more additional engine parameters such as engine inlet temperature (T1), engine exhaust temperature (EGT or T7), engine internal temperature (T4) and/or engine internal pressure (P3). Such additional measurements may be captured by specialized maintenance hardware such as, for example, thermocouples and/or pressure transducers. In some embodiments, such specialized maintenance hardware may be utilized only for maintenance purposes and may not be fitted to the engine during normal operating conditions such as when the aircraft is in flight. Such hardware may not be flight-worthy and/or may be temporarily fitted, to capture their respective measurements. Such hardware may be designed to fit existing mechanism surfaces and/or interfaces of the aircraft or engine.

For example, on a PT6A turboprop engine, an engine inlet temperature gauge typically is not provided (though it may be provided on other turbofan engines). For the PT6A turboprop engine, an engine inlet temperature gauge may be fitted to the engine air inlet area (e.g., at the engine inlet screen or aircraft inlet lips).

Specialized hardware may also be provided to measure P3. For example, the engine 10 may include existing tubes that carry air at the P3 pressure from one location on the engine 10 (e.g., the gas generator case, which may be near combustor 16) to the sensing unit or control device(s) 20. For verifying engine trim on-wing, it may be necessary to measure the P3 pressure directly. A location for such measurement may be integrated with the existing tubes carrying P3 pressure. Since the P3 air is typically filtered prior to entering the control device(s) 20, a P3 filter is typically provided in the engine 10. The P3 filter may be housed within a flight-worthy filter bowl. During maintenance procedures, the internal pressure filter bowl and filter of engine 10 may be removed and replaced with hardware (e.g., a filter bowl) including an internal pressure transducer capable of measuring P3. Pressure measured by this transducer may be transmitted to the engine monitoring device 204 and used by the trim verification algorithm 206 to calculate trim. In some examples, at the same or similar location where P3 is measured, T4 may also be measured (e.g., using a thermocouple, which may also be introduced in a filter bowl).

The incorporation of these further engine parameters (e.g. engine inlet temperature, engine exhaust temperature and/or engine internal pressure) in engine maintenance diagnostics may increase the accuracy and reliability of diagnostic results including the verification of engine temperature trim.

In some embodiments, ECTM system 202 may comprise one or more data processors for controlling operation of the system and a transmission system for sending and receiving data and one or more memory devices.

ECTM system 202 may be any suitable system for collecting engine condition information. A suitable ECTM system 202 may be as described in U.S. Pat. No. 6,915,189, the entirety of which is hereby incorporated by reference. ECTM system 202 may collect data from an operating engine, may analyze the data, and may transmit the analyzed data. In some examples, ECTM system 202 may collect and transmit the data, with analysis being performed by one or more other systems. ECTM system 202 may implement one or more protocols, such as a data collection protocol, a data analysis protocol, a data review protocol and/or a maintenance actions protocol. For example, the data collection protocol may define the flight and/or engine condition(s) at which data is to be collected, and/or the frequency of data collection. The data analysis protocol may define the calculation(s) to be performed on the collected data, and may also define alert(s) and/or notification(s) of maintenance action(s) to be generated based on the results of the analysis. The data review protocol may define the frequency at which an operator should review the results of the analysis. The maintenance actions protocol may define action(s) (which may be as described in appropriate maintenance manuals, such as in “Approved Instructions for Continued Airworthiness”) a maintainer 208 should take to resolve any alerts and/or notifications generated according to the data analysis protocol.

Engine monitoring device 204 may comprise one or more data processors for controlling operation of the device as well as a transmission system for sending and receiving data and one or more memory devices. Engine monitoring device 204 may receive engine parameters, such as those discussed above, from ECTM 202 as well as from any additional hardware, such as specialized sensors, fittings, harnesses, thermocouples and/or pressure transducers, fitted to the engine for maintenance purposes. Such data may be transmitted to engine monitoring device 204, for example, using harnesses or similar hardware or as data signals via wireless technology and received by the transmission system. In some embodiments, this data may be temporarily or permanently stored in the one or more memory devices associated with engine monitoring device 204.

Data collected by engine monitoring device 204 may be transmitted at an appropriate time for processing according to one or more trim verification algorithms 206 capable of analyzing the data for maintenance purposes. For example, trim verification algorithm(s) 206 may be adapted to calculate an optimum, or otherwise desired or recommended, trim thermocouple resistance for the engine.

The data may be transmitted to one or more processors (e.g., ground-based processors, web-based processors or other external processors) configured for processing using algorithm(s) 206 using any suitable wireless or wired transmission mechanism. For example, in some embodiments, the data may be sent as data signals to one or more processors carrying out trim verification algorithm(s) 206 using, for example, a data transmission unit (DTU) associated with the aircraft.

Trim verification algorithm(s) 206 may comprise computer readable instructions stored in one or more memory devices associated with a suitable computing device such as a PC-type or mainframe computing system. Such computing system(s) may be owned and/or operated, for example, by the owner or operator of the aircraft to which engine 10 is operatively connected or by a maintenance organization responsible for maintenance procedures associated with the aircraft. The computing system may be located proximate to the aircraft or the computing system may be located far from the aircraft, such as, for example, at a central location for the owner/operator of the aircraft.

Trim verification algorithm(s) 206 may differ in purpose from conventional ground-based algorithms and methods for engine maintenance. For example, conventional methods and algorithms may be intended to detect when there is a problem with an engine by looking for shifts in engine parameters, or to detect when there are instances where allowable engine operating parameters are exceeded. That is, conventional methods and algorithms may use data to advise a maintainer 208 to carry out certain engine maintenance tasks if a given condition is detected. Trim verification algorithm(s) 206, as presently disclosed, may use collected data to determine how to fundamentally change the trim resistance or trim setting of the engine (which may be a physical resistor or an adjustable variable within the engine control system). Conventionally, the engine trim is set during the production process and/or during the engine pass-off test, and then not changed (e.g., for many years) until the next pass-off test during an engine overhaul or major maintenance visit. The present disclosure may allow the engine trim to be changed without requiring such a pass-off test.

Once an optimum trim thermocouple resistance for the engine has been calculated by trim verification algorithm(s) 206, it may be transmitted to one or more maintainers 208 of the aircraft. Maintainer(s) 208 may comprise maintenance crew and/or machinery used in the maintenance of gas turbine engines such as gas turbine engine 10. The optimum trim thermocouple resistance may be transmitted by any suitable wired or wireless means. For example, in some embodiments, the optimum trim thermocouple resistance may be transmitted to maintainer(s) 208 by posting it to a website or transmitting it to a device, such as a hand held device, accessible to a maintenance crew. Maintainer(s) 208 may then refer to the optimum trim thermocouple resistance and compare it to the trim on the engine data plate and the actual fitted trim thermocouple resistance.

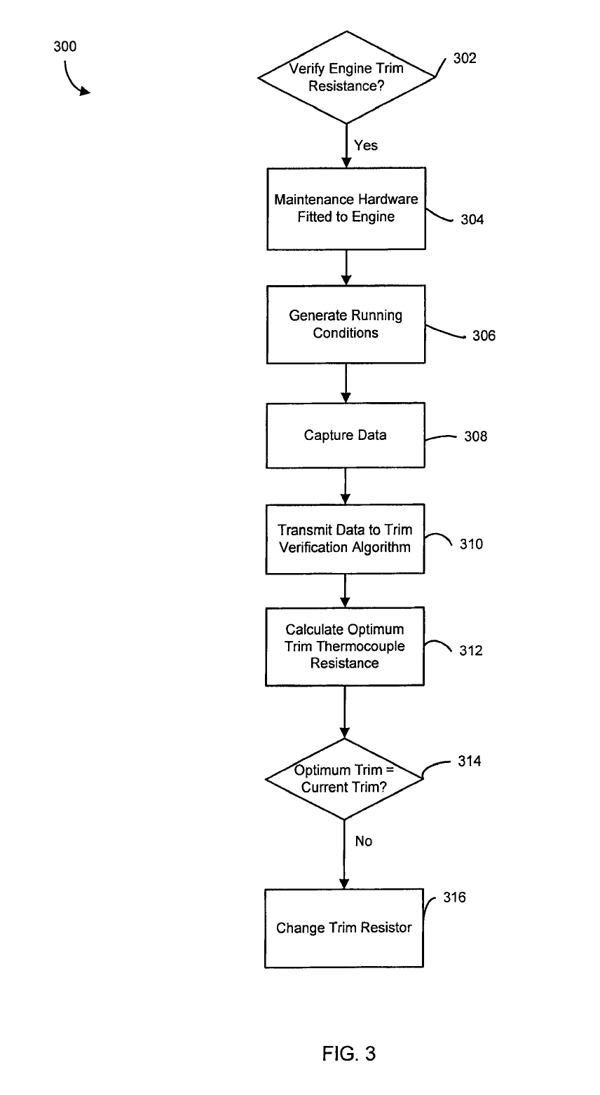

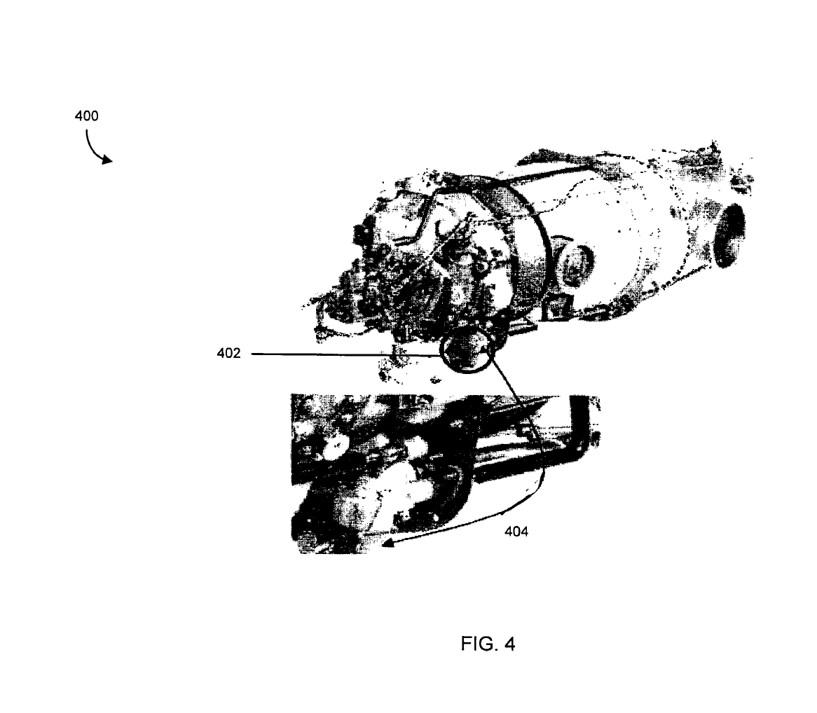

FIG. 3 schematically illustrates an exemplary method which may be used to verify the engine temperature trim while the engine 10 is on-wing. The method may be carried out through interaction between ECTM system 202, engine monitoring device 204, trim verification algorithm(s) 206 and maintainer(s) 208 such as described in relation to FIG. 2.

At 302, a maintainer 208 identifies that engine trim resistance should be verified. This may be following a hot section inspection (HSI), for example. The engine trim may be affected by changes to the engine introduced during the HSI. The HSI may be carried out on-wing, without a maintenance visit. The HSI may be carried out for the purpose of restoring the engine's operating temperature margin. The HSI may result in a change to the temperature margin (e.g., a decrease in the engine's operating temperature margin) or leave it unchanged, both cases typically being undesirable. Following the HSI, an engine maintainer 208 may determine that the temperature margin was insufficiently increased and may accordingly identify a need for engine trim resistance.

Once the determination has been made that verifying engine trim resistance is advisable, at 304, additional maintenance hardware, such as harnesses and/or fittings, may be fitted to the engine 10. In some embodiments, the additional maintenance hardware may be capable of measuring engine parameters such as engine inlet temperature (T1), engine exhaust temperature (EGT or T7), engine internal temperature (T3) and/or engine internal pressure (P3). Some or all of the maintenance hardware may be fitted to the engine 10 according to an engine maintenance manual (EMM) and/or aircraft maintenance manual (AMM) for a particular engine/aircraft. In some embodiments, the internal pressure filter bowl and filter may be removed and replaced with hardware comprising, for example, an internal pressure transducer capable of measuring internal engine pressure.

At 306, the engine 10 may be run in order to generate running conditions for the engine 10, for example, as per the EMM. At 308, engine parameters measured by ECTM system 202 as well as any additional maintenance hardware fitted to the engine 10 may be captured by an engine monitoring device 204. The captured data may be transmitted to one or more trim verification algorithms 206 at 310 through any suitable wired or wireless means. For example, in some embodiments, the captured data may be transmitted using a data transmission unit (DTU) associated with the aircraft. In some embodiments, by receiving additional parameters such as the engine inlet temperature (T1), engine exhaust temperature (EGT or T7), engine internal temperature (T4) and/or engine internal pressure (P3) which would not normally be collected for non-maintenance purposes, the one or more trim verification algorithms 206 may determine that the engine trim is to be calibrated.

At 312, the one or more trim verification algorithms 206 receive the engine data and calculate an optimum, or otherwise desired or recommended, trim thermocouple resistance for the engine. The optimum trim thermocouple resistance is then transmitted back to maintainers 208 as described above.

Trim verification algorithm(s) 206 may receive one or more inputs, perform one or more calculations, and provide one or more outputs. For example, input(s) to the trim verification algorithm(s) 206 may include ECTM parameter(s) as well as any additional inputs from one or more specialized hardware, as described above. Input(s) may also include a quantified value representing a change to the compressor turbine (CT) and/or power turbine (PT) vane flow areas. For example, during a HSI, the CT and/or PT vane may be replaced with one or more refurbished components. The replacement component(s) may have different flow area(s), which may affect engine performance parameters. Information about the engine pass-off test performance (e.g., from production or from an overhaul) may also be provided as input. Information from the pass-off test may be available from an engine logbook and/or a database.

Trim verification algorithm(s) 206 may carry out one or more calculations using the received input(s), to validate the current engine trim. Calculation(s) may be carried out to revise the trim value according to appropriate formulae. Engine parameters may be recorded at stabilized operating conditions. The data required may include but is not limited to a full set of engine parameters and other data such as: Engine Inlet Temperature (T1), Exhaust Temperature (T7), Engine Speeds Ng and Np, Specific Fuel Gravity (SG), Fuel temperature (Tf), Atmospheric Pressure (Pamb), Compressor Discharge Pressure (P3), and Fuel Flow (Wf). From the above parameters, the untrimmed engine internal temperature (ITT or T4) may be determined using the engine manufacturer's supplied procedure(s).

Trim verification algorithm(s) 206 may provide one or more output(s), for example a single output value. For example, the single output value may be the recommended trim resistance, where the engine has a physical resistor; or a recommended trim setting, where the engine has electronic controls for resistance.

The recommended trim resistance may be implemented as appropriate, for example according to the “Instructions for Continued Airworthiness”, including the maintenance manual for the engine.

At 314, maintainer(s) 208 may compare the received optimum trim thermocouple resistance to the trim value on the engine data plate and the actual fitted trim thermocouple resistance. If the trims are different, maintainer(s) 208 may follow procedures described, for example, in the EMM, to change the engine trim resistor to match the recommended optimum trim thermocouple resistance at 316.

Although the disclosure refers to “optimum” and “optimizing”, such terms may be used to refer to an improved, desired or recommended result, which may not necessarily be absolutely optimal.

Although an engine trim resistor is described in some examples, the engine may alternatively or additionally include a trim plug having multiple resistors. In some examples, the engine may include an electronic control providing a trim setting.

The present disclosure describes the use of measurement hardware that may not be flight-worthy. Use of such hardware may be limited to trim verification on the ground and/or at infrequent intervals. In some examples, one or more pieces of measurement hardware may be flight-worthy and may be fitted on the engine for measurements in the air. This may allow for in-air, frequent and/or continuous evaluation of the engine trim, and may allow for continuous or near-continuous optimization of the engine trim.

In some examples, the trim verification system 200 may also be used to determine if one or more engine temperature probes (e.g., an engine internal temperature probe) has malfunctioned or stopped functioning. For example, a malfunction of one probe out of a set of probes (e.g., typically a set of 8-10 of such probes) may result in a shift in the engine temperature indicated in the cockpit. The trim verification system 200 may determine that this shift is not due to a change in the engine performance, but rather the malfunction of a probe, and a notification or alert may be generated accordingly. If such a probe malfunction is determined, further engine maintenance may be delayed until the engine performance significantly deteriorates and an overhaul is required.

Except to the extent necessary or inherent in the processes themselves, no particular order to steps or stages of methods or processes described in this disclosure, included the Figures, is intended or implied. In many cases the order of process steps may be varied without changing the purpose, effect or import of the methods described. The scope of the invention is to be defined solely by the appended claims.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

What is claimed is:

1. A method of controlling a temperature trim of a gas turbine engine, the method comprising:
acquiring from transducers associated with the gas turbine engine signals representing a plurality of engine parameters measured while the engine is operating, the parameters comprising at least an engine inlet temperature and an exhaust temperature; and
transmitting signals representing the measured parameters to a processor, the processor determining a recommended trim thermocouple resistance based at least partly on the measured parameters.

2. The method of claim 1, wherein the method is performed while the engine is operationally connected to an aircraft.

3. The method of claim 1, wherein at least one of engine inlet temperature and exhaust temperature is measured using test hardware fitted to the engine during maintenance.

4. The method of claim 1, wherein the plurality of engine parameters further comprises at least one of: engine internal pressure, engine internal temperature, torque, speed, air temperature, altitude and fuel flow.

5. The method of claim 4, wherein the engine internal pressure is measured using an internal pressure transducer fitted in the place of a pressure filter and a filter bowl.

6. The method of claim 4, wherein the engine internal temperature is measured using a thermocouple fitted in the place of a pressure filter and a filter bowl.

7. The method of claim 1, wherein transmitting signals representing the measured parameters to the processor comprises transmitting the one or more engine parameters to an engine monitoring device, the engine monitoring device transmitting the one or more engine parameters to the processor.

8. The method of claim 1, the method further comprising:
determining that when one or more of an engine internal pressure, the engine inlet temperature and the exhaust temperature are measured, an engine condition trend monitoring system is operating in engine trim calculation mode.

9. The method of claim 1, wherein the recommended trim thermocouple resistance is one or more of: posted to a website and transmitted to a handheld device.

10. The method of claim 1, the method further comprising:
comparing the recommended trim thermocouple resistance to a trim value on an engine data plate and an actual fitted trim thermocouple resistance; and
if the recommended trim thermocouple resistance is different from the trim value on the engine data plate and the actual fitted trim thermocouple resistance, changing the trim resistor to match the recommended trim thermocouple resistance.

11. A device useful in controlling a temperature trim of a gas turbine engine, the device comprising:
a processor to control operation of the device; and
a transmission system configured to:
receive from transducers associated with the gas turbine engine, a plurality of engine parameters measured while the engine is operating, the parameters comprising at least an engine inlet temperature and an exhaust temperature; and
transmit signals representing the measured parameters to a processor, the processor determining a recommended trim thermocouple resistance based at least partly on the measured parameters.

12. The device of claim 11, wherein the device is adapted to control the temperature trim of a gas turbine engine while the engine is operationally connected to the aircraft.

13. The device of claim 11, wherein at least one of engine inlet temperature and exhaust temperature is measured using hardware fitted to the engine during maintenance.

14. The device of claim 11, wherein the plurality of engine parameters further comprises at least one of: engine internal pressure, engine internal temperature, torque, speed, air temperature, altitude and fuel flow.

15. The device of claim 14, wherein the engine internal pressure is measured using an internal pressure transducer fitted in the place of a pressure filter and a filter bowl.

16. The device of claim 14, wherein the engine internal temperature is measured using a thermocouple fitted in the place of a pressure filter and a filter bowl.

17. The device of claim 11, wherein the device forms part of an engine monitoring device.

18. The device of claim 11, wherein the processor is further configured to recognize that when one or more of an engine internal pressure, the engine inlet temperature and the exhaust temperature are measured, an engine condition trend monitoring system is operating in an engine trim calculation mode.

19. An aircraft comprising the device of claim 11.
